(19) United States
(12) Patent Application Publication
(10) Pub. No.: US 2007/0129981 A1
(43) Pub. Date: Jun. 7, 2007

(54) Business solution management

(75) Inventors: Yunhee Jang, Poughkeepsie, NY (US); Juhnyoung Lee, Yorktown Heights, NY (US); Grace Y. Lin, Chappaqua, NY (US); David D. Yao, Yorktown Heights, NY (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/295,828

(22) Filed: Dec. 7, 2005

(51) Int. Cl. G06F 9/46

(52) U.S. Cl. 705/8

(57) ABSTRACT

A method, system, and program product for managing one or more business solutions is provided. One or more candidate business solutions, each of which has a corresponding set of resource requirements and a corresponding business value that is based on a risk and an expected return are used to generate a set of proposed business solutions that maximizes a total value while remaining within a set of resource constraints. In this manner, business decisions regarding particular business solutions to implement can be made with an understanding as to relative risk and/or a total value that will be provided to a business entity.

### REFERENCE TO RELATED APPLICATIONS

The current application is related to co-owned and co-pending U.S. patent application Ser. No. 11/200,847, filed on Aug. 10, 2005, and entitled “Business Solution Evaluation”, and co-owned and co-pending U.S. patent application Ser. No. 11/200,727, filed on Aug. 10, 2005, and entitled “Value Model”, both of which are hereby incorporated herein by reference.

### FIELD OF THE INVENTION

The invention relates generally to business solution management, and more particularly, to a solution for identifying and/or selecting a set of business solutions to implement that seeks to provide the most value to a business while accounting for risk and one or more constraints.

### BACKGROUND OF THE INVENTION

One of the most important challenges that any business faces is the selection and subsequent implementation of business solutions, such as technology projects. The business considers undertaking such investments in order to boost its bottom line financial metrics and ensure its long-term competitiveness in a marketplace of increasing reliance on technological innovation. However, the decision of whether or not to invest in a set of business solutions is not a simple one. Real world considerations are far too complex to be captured in a single model. A host of budgetary, regulatory, marketing, and overall strategic factors may come into play when the business attempts to address its technology needs and goals.

Project portfolio management comprises the management of a dynamic portfolio of business solutions that are ongoing/proposed to address one or more business pain points, and their corresponding financial and operational metrics. One aspect of project portfolio management is project portfolio optimization, which provides decision support for selecting one or more candidate business solutions by prioritizing them based on their potential to improve business performance while meeting one or more constraints, such as a budget, resource availability (e.g., human, facility, information technology, etc.). Project portfolio optimization generally seeks to maximize the value delivered by the business solutions given the objectives (e.g., pain points) of the business and the constraints.

Several approaches have been proposed to address the selection of business solutions (projects) for a portfolio. In one approach, a model is developed to optimize a portfolio of product development improvement policies for a set of interdependent projects over a multiple period time frame in a common funding cycle. The model selects if and when to fund a project in the time frame, and assumes that once a project has started receiving funding, it will continue to do so throughout the duration of the cycle. The approach uses a dependency matrix structure that identifies interdependencies between projects, and optimizes the selected projects with respect to net present value (NPV) while imposing three main constraints: budgetary, quantity of projects in the portfolio, and quantity of projects supporting each strategic incentive. The subsequent non-linear integer program is then solved using a spreadsheet-based solver. Another approach uses a dynamic programming framework to generate a project portfolio. In this case, the expected NPV of the project portfolio is maximized by allocating a limited amount of resources to projects over time. The approach uses an index policy that obtains the optimal solution under certain environmental conditions, and works well in the general framework.

An alternative approach uses software that optimizes complex functions over a set of linear and non-linear constraints, while imposing bounds on the decision variables. The linear constraints may reflect budgetary limits while the non-linear constraints may attempt to capture risk/volatility levels of tolerance. The approach evaluates the objective function and non-linear constraint functions using a Monte Carlo simulation of a project portfolio. Subsequently, an optimization algorithm uses the output from the simulation and previously obtained outputs to decide upon a new set of input values. In this case, the trajectory of solutions converges to the best solutions and a criterion for terminating the process, e.g., a number of iterations, can be selected by a user.

In financial planning, classical Markowitz theory provides that given a certain level of expected return that an investor desires, the expected volatility of the financial portfolio is minimized. Alternatively, given a level of volatility that is acceptable, the expected return on the financial portfolio is maximized. Assuming complete knowledge of the expected return vector of assets as well as the covariance between different returns, the expected volatility can be minimized by solving a convex quadratic program, while the expected return can be maximized by optimizing a linear objective subject to quadratic constraints. While theoretically appealing, this approach is not successful in practice since the optimal portfolio is extremely sensitive to uncertain market parameters, which cannot be captured with any reasonable degree of certainty.

As a result, financial planners have developed various approaches that seek to provide the desired minimization/maximization (optimization). In one approach, alternative deterministic models that take into account market data uncertainty are used to model perturbations in market parameters as unknown, but bounded, and solve optimization problems by assuming the worst case behavior of these perturbations. In this case, the classical Markowitz problems can be reformulated as robust optimization problems, thus tempering the sub-optimality that can result from the optimal solution's high sensitivity to the input parameters.

Alternatively, another approach develops a model by accounting for information about order relations between different returns. The model accepts investors' beliefs about the relative order of the expected asset returns as input, rather than the exact numerical values. The beliefs are described in terms of homogeneous linear relationships, with each being expressed in a compact mathematical form as a linear combination of expected returns being greater than or equal to zero. Using this ordering information, “optimal” portfolios can be computed under a variety of constraints.

Still another approach devises an optimal strategy to minimize the expected cost of managing and trading a large block of equity over a fixed time horizon. The inputs are a fixed block of shares, state dynamics, and a price-impact function that yields the execution price of an individual trade as a function of the shares traded and other state variables. In this case, the theory of dynamic programming is used to compute an optimal sequence of trades as a function of the state variables that minimize the expected cost of executing the block of shares within a number of periods.

In view of the foregoing, there exists a need in the art to overcome one or more of the deficiencies indicated herein.

### SUMMARY OF THE INVENTION

The invention provides a solution for managing one or more business solutions. One or more candidate business solutions, each of which has a corresponding set of resource requirements and a corresponding business value that is based on a risk and an expected return are used to generate a set of proposed business solutions that maximizes a total value while remaining within a set of resource constraints. In this manner, business decisions regarding particular business solutions to implement can be made with an understanding as to relative risk and/or a total value that will be provided to a business entity.

A first aspect of the invention provides a method of managing a set of business solutions, the method comprising: obtaining a set of candidate business solutions, wherein each candidate business solution comprises a corresponding set of resource requirements and a corresponding business value that is based on a risk and an expected return for the candidate business solution; obtaining a set of resource constraints; and generating a set of proposed business solutions that maximizes a total value while remaining within the set of resource constraints.

A second aspect of the invention provides a system for managing a set of business solutions, the system comprising: a system for obtaining a set of candidate business solutions, wherein each candidate business solution comprises a corresponding set of resource requirements and a corresponding business value that is based on a risk and an expected return for the candidate business solution; a system for obtaining a set of resource constraints; and a system for generating a set of proposed business solutions that maximizes a total value while remaining within the set of resource constraints.

A third aspect of the invention provides a program product stored on a computer-readable medium, which when executed, enables a computer infrastructure to manage a set of business solutions, the program product comprising computer program code for enabling the computer infrastructure to: obtain a set of candidate business solutions, wherein each candidate business solution comprises a corresponding set of resource requirements and a corresponding business value that is based on a risk and an expected return for the candidate business solution; obtain a set of resource constraints; and generate a set of proposed business solutions that maximizes a total value while remaining within the set of resource constraints.

A fourth aspect of the invention provides a method of generating a system for managing a set of business solutions, the method comprising: providing a computer infrastructure operable to: obtain a set of candidate business solutions, wherein each candidate business solution comprises a corresponding set of resource requirements and a corresponding business value that is based on a risk and an expected return for the candidate business solution; obtain a set of resource constraints; and generate a set of proposed business solutions that maximizes a total value while remaining within the set of resource constraints.

A fifth aspect of the invention provides a business method for managing a set of business solutions, the business method comprising managing a computer infrastructure that performs the process described herein; and receiving payment based on the managing.

The illustrative aspects of the present invention are designed to solve the problems herein described and other problems not discussed.

### BRIEF DESCRIPTION OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a set of business solutions according to an embodiment of the invention.

FIG. 2 shows an illustrative process for generating a set of proposed business solutions according to an embodiment of the invention.

FIGS. 3A-C show illustrative component business maps according to an embodiment of the invention.

FIG. 4 shows an illustrative value model according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the invention provides a solution for managing one or more business solutions. One or more candidate business solutions, each of which has a corresponding set of resource requirements and a corresponding business value that is based on a risk and an expected return are used to generate a set of proposed business solutions that maximizes a total value while remaining within a set of resource constraints. In this manner, business decisions regarding particular business solutions to implement can be made with an understanding as to relative risk and/or a total value that will be provided to a business entity. As used herein, unless otherwise noted, the term “set” means one or more.

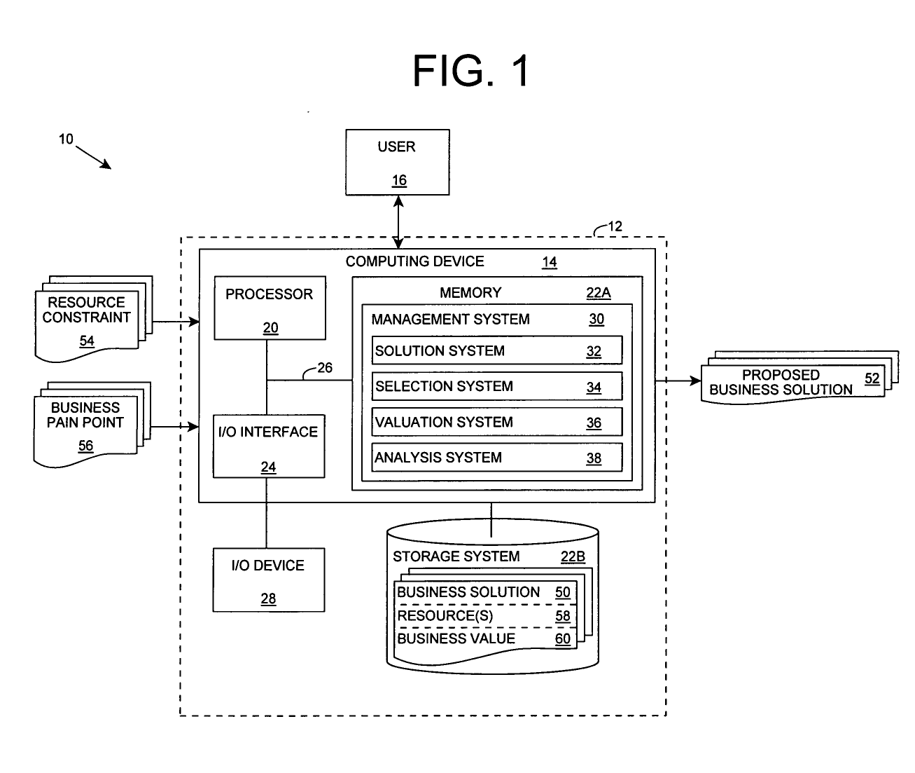

Turning to the drawings, FIG. 1 shows an illustrative environment 10 for managing a set of business solutions 50 according to an embodiment of the invention. To this extent, environment 10 includes a computer infrastructure 12 that can perform the process described herein in order to manage the set of business solutions 50. In particular, computer infrastructure 12 is shown including a computing device 14 that comprises a management system 30, which makes computing device 14 operable to manage the set of business solutions 50 by performing the process described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as management system 30, which is stored in memory 22A and/or storage system 22B. While executing computer program code, processor 20 can read and/or write data, such as business solution 50, to/from memory 22A, storage system 22B, and/or I/O interface 24. Bus 26 provides a communications link between each of the components in computing device 14. I/O device 28 can comprise any device that enables an individual to interact with computing device 14 or any device that enables computing device 14 to communicate with one or more other computing devices using any type of communications link.

In any event, computing device 14 can comprise any general purpose computing article of manufacture capable of executing computer program code installed thereon (e.g., a personal computer, server, handheld device, etc.). However, it is understood that computing device 14 and management system 30 are only representative of various possible equivalent computing devices that may perform the process described herein. To this extent, in other embodiments, the functionality provided by computing device 14 and management system 30 can be implemented by a computing article of manufacture that includes any combination of general and/or specific purpose hardware and/or computer program code. In each embodiment, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link, such as a network, a shared memory, or the like, to perform the process described herein. Further, while performing the process described herein, one or more computing devices in computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

As discussed herein, management system 30 enables computer infrastructure 12 to manage the set of business solutions 50. To this extent, management system 30 is shown including a solution system 32, a selection system 34, a valuation system 36 and an analysis system 38. Operation of each of these systems is discussed further herein. However, it is understood that some of the various systems shown in FIG. 1 can be implemented independently, combined, may not be implemented, or additional systems and/or functionality may be included as part of computer infrastructure 12.

Regardless, solution system 32 manages a set of business solutions 50. Each business solution 50 comprises a potential project, an available product/service, and/or the like, that can address one or more business pain points 56. Solution system 32 can enable a user 16 to perform various operations (e.g., add/remove/modify/view) on the set of business solutions 50 using any known solution. To this extent, solution system 32 can provide an application program interface (API) that enables another system (e.g., user 16) to perform/request various operations on business solution(s) 50. Similarly, solution system 32 can generate a user interface that enables user 16 to request various operations on business solution(s) 50.

Solution system 32 can manage a corresponding set of required resources 58 and/or business values 60 for each business solution 50. Each resource 58 can comprise an amount of time required, a number of man-hours, IT requirements, and/or the like, that is required to implement the corresponding business solution 50. Business value 60 can comprise any value assigned to the corresponding business solution 50, and can be expressed as a relative percentage and/or absolute increase/decrease to a resource and/or business concern. Solution system 32 can enable user 16 and/or another system to perform various operations on the set of resources 58 and/or business values 60 for each business solution 50 by, for example, providing an API, generating a user interface, and/or the like.

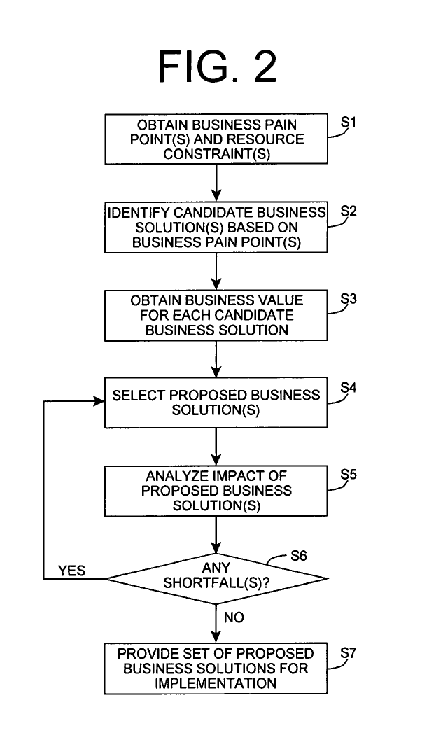

In any event, selection system 34 generates a set of proposed business solutions 52 from the set of business solutions 50. Further details of the operation of management system 30 are discussed with reference to FIG. 2, which shows an illustrative process for generating the set of proposed business solutions 52 according to an embodiment of the invention. Referring to FIGS. 1 and 2, in step S1, selection system 34 obtains a set of business pain points 56. Each business pain point 56 can define any business area that a business seeks to implement and/or improve. For example, business pain point 56 can comprise a business problem, a goal of increasing value (e.g., shareholder value), a goal of improving profitability, a new business area/solution, and the like.

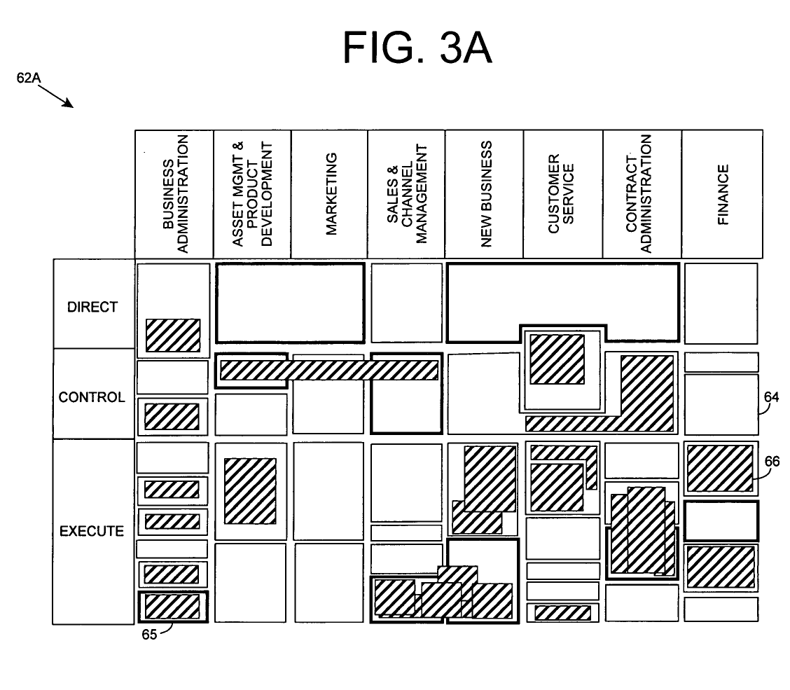

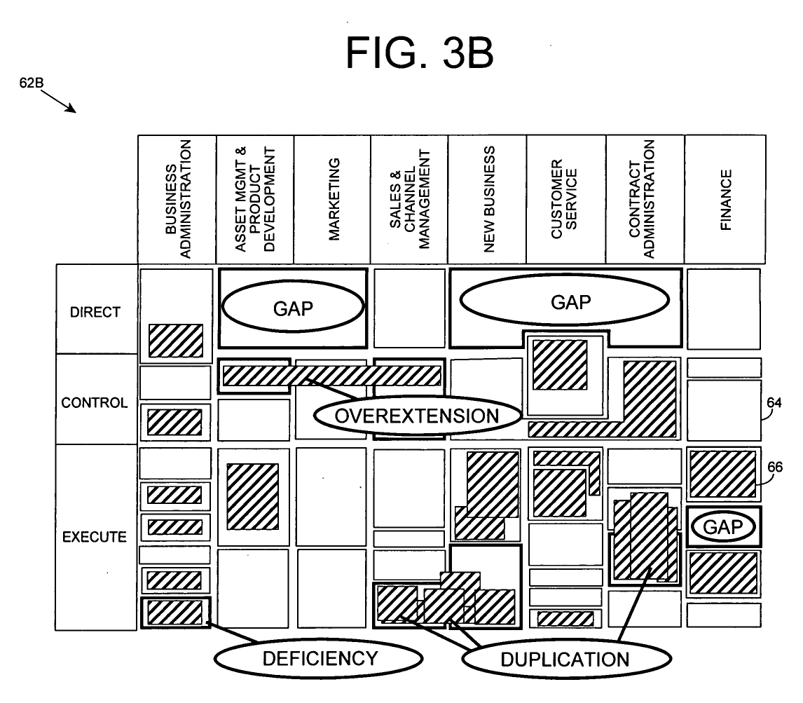

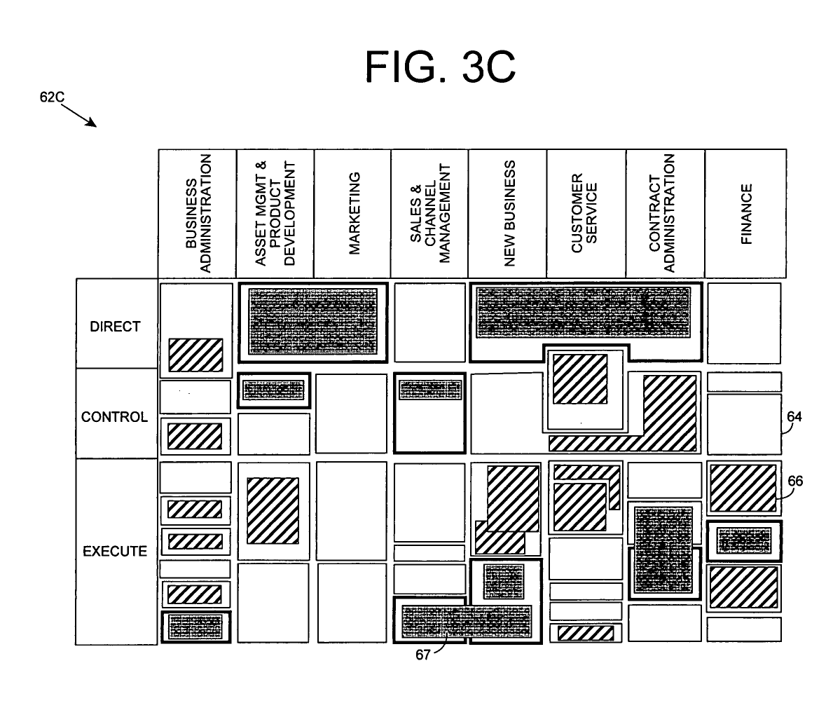

Regardless, in step S2, selection system 34 identifies one or more candidate business solutions from the set of business solutions 50 that are available. Each candidate business solution 50 can fulfill some or all of the goal(s) defined by the business pain point(s) 56. In one embodiment, selection system 34 identifies a set of business components associated with each business pain point 56. For example, selection system 34 can use a component business map for the business entity as shown and described in the co-owned and co-pending U.S. patent application Ser. No. 11/200,847, filed on Aug. 10, 2005, and entitled “Business Solution Evaluation”, which was previously incorporated herein by reference. To this extent, FIG. 3A shows an illustrative component business map 62A. In general, component business map 62A includes various business components, such as business component 64, with their corresponding business solutions, such as business solution 66. Selection system 34 can identify each business component 64 associated with a particular business pain point 56 (FIG. 1), and can indicate the business component(s) 64 in component business map 62A as “hot” business components, such as business component 65.

Selection system 34 (FIG. 1) can use component business map 62A to identify and/or categorize a set of shortfalls that are responsible for the business pain point(s) 56. For example, FIG. 3B shows an illustrative component business map 62B having several shortfalls identified. In general, shortfalls can be classified in one of several categories: a “gap” shortfall is present when there is no business solution 66 for a particular “hot” business component 64; a “deficiency” shortfall is present when the capability of the business solution 66 is not addressing all of the requirements of the business component 64; a “duplication” shortfall is present when multiple business solutions 66 that provide overlapping functionality are present for a particular business component 64; and an “overextension” shortfall is present when a single business solution 66 provides functionality for multiple business components 64, thereby being stretched beyond its capabilities. Each type of shortfall can be addressed using a different solution: a gap shortfall can be addressed by adding a new business solution 66; a deficiency shortfall can be addressed by replacing and/or enhancing the business solution 66; a duplication shortfall can be addressed by consolidating business solutions 66; and an overextension shortfall can be addressed by splitting the business solution 66.

In any event, selection system 34 (FIG. 1) can generate a set of candidate business solutions from the set of business solutions 50 (FIG. 1) based on the shortfalls identified in component business map 62B. To this extent, FIG. 3C shows an illustrative component business map 62C, in which several candidate business solutions, such as candidate business solution 67, are included to address the various shortfalls. It is understood that selection system 34 can generate the set of candidate business solutions 67 using any type of automated, semi-automated, and/or manual solution. For example, selection system 34 can enable user 16 (FIG. 1) to view component business map 62C and selectively add and/or remove candidate business solutions 67. Selection system 34 can automatically add one or more candidate business solutions 67 based on a comparison between the functionality of a particular candidate business solution 67 and the requirements of a particular hot business component 65.

In any event, returning to FIGS. 1 and 2, in step S3, for each candidate business solution 50, valuation system 36 can determine the corresponding business value 60. Business value 60 can be expressed in terms of an expected return and a risk. Valuation system 36 can use any known valuation solution for determining business value 60. In one embodiment, valuation system 36 provides various information on business solution 50 to another system, which returns business value 60. Alternatively, valuation system 36 can determine business value 60 by, for example, using a value model. The value model can comprise any type of model that assigns a value to a particular business solution 50. For example, the value model can assign an expected return as a relative percentage increase/decrease to the value obtained when one or more attributes of a business concern or the like are increased/decreased as a result of the business solution 50. Further, the value model can include relationship information for the various business concerns. The relationship information can define a percentage contribution, or the like, that one business concern provides for another business concern. Additional information, such as a risk, expressed as an error margin, high/low value range, or the like, can also be included in value model 60. In one embodiment, value model 60 comprises a value model as shown and described in the co-owned and co-pending U.S. patent application Ser. No. 11/200,727, filed on Aug. 10, 2005, and entitled “Value Model”, which was previously incorporated herein by reference. However, it is understood that this is only illustrative, and any value model can be used.

Returning briefly to step S1, selection system 34 can further receive a set of resource constraints 54. Each resource constraint 54 can comprise any type of limitation on any type of resource, such as time, money, infrastructure, and/or the like. For example, a resource constraint 54 can comprise a total amount of capital available, an amount of and/or type of available infrastructure (e.g., configuration of information technology (IT) environment, facility space available, processing/communications availability, etc.), a quantity of human resources (e.g., man-hours, skill level, expertise, etc.), a time limitation, and/or the like. In this case, in step S4, selection system 34 generates the set of proposed business solutions 52 from the set of candidate business solutions 50, such that the total resources 58 required by the proposed business solutions 52 remains within the set of resource constraints 54. To this extent, selection system 34 can initially determine that the required resources 58 of a particular business solution 50 are within the resource constraints 54, and if so, selection system 34 can add the business solution 50 to the set of proposed business solutions 52 and reduce the total amount of resources available within the set of resource constraints 54 by the required resources 58.

Further, in step S4, selection system 34 can generate the set of proposed business solutions 52 in a manner that maximizes a total value of proposed business solutions 52 while remaining within the set of resource constraints 54. In particular, selection system 34 can compare the business value 60 provided by the various business solutions 52 in reference to a business entity's utility function, which can quantify one or more business objectives of the business entity. Business value 60 can be expressed in terms of a risk and expected return. In this case, selection system 34 can generate the set of proposed business solutions 52 so as to optimize the business entity's utility function while remaining within the set of resource constraints 54. In one embodiment, selection system 34 generates the set of proposed business solutions 52 by solving one or more unconstrained sub-modular function minimization (SFM) problems in order to maximize the total value. Various algorithms are known that execute in polynomial time in order to solve SFM problems.

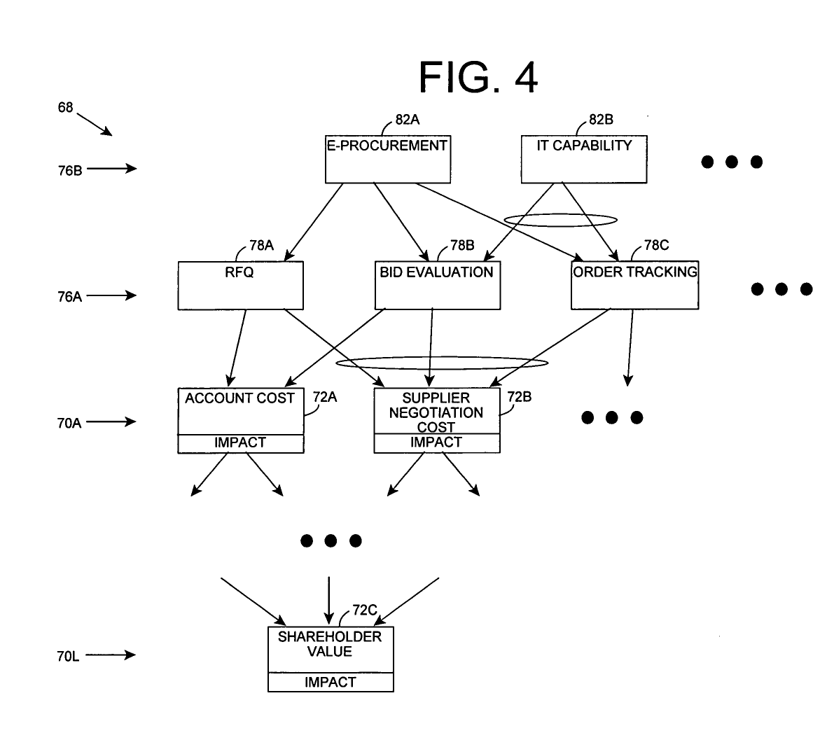

To this extent, selection system 34 can generate an efficient (Pareto optimal) set of proposed business solutions 52 using a value model. For example, FIG. 4 shows an illustrative value model 68 as described in the co-owned and co-pending U.S. patent application Ser. No. 11/200,727, filed on Aug. 10, 2005, and entitled “Value Model”, which was previously incorporated herein by reference. Value model 68 includes one or more enterprise levels 76A-B, each of which includes one or more enterprise function nodes 78A-C, 82A-B. Each enterprise level 76A-B can comprise enterprise function nodes 78A-C, 82A-B that represent a particular type of enterprise function. In one embodiment, enterprise function nodes 78A-C each represent a business activity, while enterprise function nodes 82A-B each represent an information technology capability. Further, value model 68 includes one or more driver levels 70A-L, each of which includes one or more driver metric nodes 72A-C.

In value model 68, an enterprise function node, such as node 82A is connected to another enterprise function node, such as node 78A when the business activity represented by enterprise function node 78A (e.g., RFQ) is affected by a change in/implementation of the business activity represented by node 82A (e.g., e-procurement). Similarly, a driver metric node, such as node 72C, is connected to another driver metric node, such as node 72A, when the performance/financial metric represented by node 72C (e.g., shareholder value) is affected by a change in the performance metric represented by node 72A (e.g., account cost). Further, a driver metric node, such as node 72A, is connected to an enterprise function node, such as node 78A, when the performance/financial metric represented by node 72A (e.g., account cost) is affected by a change in/implementation of the business activity represented by node 78A (e.g., RFQ).

Selection system 34 (FIG. 1) can use value model 68 to evaluate the business value (as represented by one or more performance/financial metrics) of one or more enterprise functions using a set of utility functions. In this manner, value model 68 can transform changes in one or more key performance indicators (e.g., business activities, performance metrics) into a particular financial metric. Value model 68 can be used to solve the formula:

$$\overline{V} ( A ) = {\sum }_{f ∈ O} E [ {v}_{f} ( {\sum }_{k ∈ L \text{:} k \to f} {n}_{k} ( A ) ) ]$$

in which nₖ(A) is the value of a node k in level L when all business activities are in effect, f is a financial metric (e.g., shareholder value), and v_{f}(•) is a utility function that transforms (e.g., converts and combines) the key performance indicators at level L into the financial metric with an associated risk level expressed as a probability and confidence interval.

Value model 68 and the corresponding utility functions, v_{f}(•), can be used to generate a set of portfolios that are “efficient” in terms of the cost-value tradeoff and/or the risk-return tradeoff. To this extent, assuming: E is a set of candidate business functions; A is a subset of E; V̅ (A) is the mean of the value of subset A; V^{σ} (A) is the standard deviation of the value of subset A; and C(A) denotes the associated cost (for purchasing and/or implementing the business functions); then the following optimization problems can be solved:

$${min}_{A ⊆ E} [ C ( A ) - λ \overline{V} ( A ) ] ; and$$

$${min}_{A ⊆ E} [ {V}^{σ} ( A ) - λ \overline{V} ( A ) ]$$

where λ is a sequence of values such that λ≧0, and λ₁<λ₂< . . . λₙ. In particular, the optimization problems can be solved for a series of λ values to generate the set of efficient portfolios. Consequently, for any two projects, A₁ and A₂, in the series:
C(A₁)<C(A₂) if f V̅(A₁)< V̅(A₂); and Equation 1
V^{σ}(A₁)<V^{σ}(A₂) if f V̅(A₁)< V̅(A₂). Equation 2
Further, for each fixed λᵢ value, a submodular function minimization algorithm or a suitable heuristic can be used. Denoting the minimizers as:
(Aᵢ)ᵢ₌₁ⁿ and (Bᵢ)ᵢ₌₁ⁿ. Then:
(C(Aᵢ), V̅(Aᵢ))ᵢ₌₁ⁿ and (V^{σ}(Bᵢ), V̅(Bᵢ))ᵢ₌₁ⁿ
are efficient solutions. In particular, both satisfy the properties in Equations 1 and 2. As a result, the resulting set of portfolios are cost-value efficient, e.g., a portfolio that has a higher cost provides a higher business value and/or risk-return efficient, e.g., a portfolio that has a higher risk/volatility provides a higher expected business value.

From the set of efficient portfolios, selection system 34 (FIG. 1) can select a set of proposed business solutions 52. In particular, to be cost-value efficient, a portfolio (e.g, a subset, Aᵢ, of candidate business solutions 50) can be selected that is within the resource constraints and provides the lowest risk, e.g., as measured by V^{σ}(Aᵢ) or the like. Alternatively, a portfolio that is within the resource constraints and has a greatest expected value can be selected. Further, to be risk-return efficient, a portfolio (e.g., a subset, Bᵢ, of candidate business solutions 50) can be selected that has a risk/volatility that is below a particular risk level as measured by V^{σ}(Bᵢ and is the least expensive, e.g., has the smallest C(Bᵢ) value. Alternatively, a portfolio that has a risk/volatility that is below the risk level and having a greatest expected value can be selected.

In step S5, analysis system 38 can analyze an impact of the set of proposed business solutions 52 on one or more business components for a business entity. To this extent, analysis system 38 can determine whether requirements for one or more business components are not addressed and/or inefficiently addressed by proposed business solutions 52. In one embodiment, analysis system 38 can use component business maps 62A-C (FIGS. 3A-C). In this case, analysis system 38 can generate a component business map that includes both existing business solutions as well as the set of proposed business solutions 52. To this extent, analysis system 38 (FIG. 1) can identify the one or more business components 64 that are impacted by each proposed business solution 52, and overlay the proposed business solution 52 on the impacted business component(s) 64 in the component business map. Analysis system 38 can provide the component business map for display to user 16.

In step S6 of FIG. 2, analysis system 38 can determine whether the set of proposed business solutions 52 includes any shortfalls (e.g., gap, deficiency, duplication, overextension). Additionally, a shortfall can comprise any type of undesirable outcome of implementing the set of proposed business solutions 52. For example, a shortfall can comprise a negative effect of implementing proposed business solution(s) 52 in conjunction with existing business solutions. To this extent, analysis system 38 can use value model 68 (FIG. 4) to identify any negative and/or synergistic effects of implementing the proposed business solutions 52 in conjunction with the existing business solutions 66. In this manner, a more accurate total value of the set of proposed business solutions 52 can be determined and/or a shortfall due to one or more negative effects can be identified.

Should analysis system 38 (FIG. 1) identify one or more shortfalls, processing can return to step S4 of FIG. 2. In this case, analysis system 38 can provide one or more additional business pain points 56 (FIG. 1) that are identified in the analysis and are to be addressed by the set of proposed business solutions 52. For example, the business pain points 56 can comprise a previously undisclosed gap, a limitation on one or more of the available business solutions 50 (FIG. 1), a negative impact of one or more business solutions 50, and/or the like. In any event, selection system 34 (FIG. 1) can generate a revised set of proposed business solutions 52 that address the shortfall(s) and analysis system 38 can overlay the revised set of proposed business solutions 52 on component business map 62C as illustratively shown in FIG. 3C.

This process can be repeated as desired to generate a set of proposed business solutions 52 that satisfies all business pain points 56 while remaining within the various resource constraints 54. In this manner, the business value provided is maximized and the portfolio of proposed business solutions 52 can be made consistent with existing solutions. Once the set of proposed business solutions 52 does not include any shortfalls to be addressed, then in step S7, management system 30 (FIG. 1) can provide the set of proposed business solutions 52 for implementation. For example, management system 30 can provide the set of proposed business solutions 52 to another system and/or generate a user interface for display to user 16 (FIG. 1) that displays the various proposed business solution(s) 52. Regardless, more informed business decisions then can be made by using the set of proposed business solutions 52.

While shown and described herein as a method and system for managing a set of business solutions, it is understood that the invention further provides various alternative embodiments. For example, in one embodiment, the invention provides a program product stored on a computer-readable medium, which when executed, enables a computer infrastructure to manage a set of business solutions. To this extent, the computer-readable medium includes program code, such as management system 30 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), as a data signal traveling over a network (e.g., during a wired/wireless electronic distribution of the program product), and/or the like.

In another embodiment, the invention provides a method of generating a system for managing a set of business solutions. In this case, a computer infrastructure, such as computer infrastructure 12 (FIG. 1), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising, and/or fee basis. That is, a service provider, such as an Application Service Provider, could offer to manage a set of business solutions as described herein. In this case, the service provider can manage (e.g., create, maintain, support, etc.) a computer infrastructure, such as computer infrastructure 12 (FIG. 1), that performs the process described herein for one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a set of business solutions, the method comprising:
obtaining a set of candidate business solutions, wherein each candidate business solution comprises a corresponding set of resource requirements and a corresponding business value that is based on a risk and an expected return for the candidate business solution;
obtaining a set of resource constraints; and
generating a set of proposed business solutions that maximizes a total value while remaining within the set of resource constraints.

2. The method of claim 1, wherein the obtaining the set of candidate business solutions includes:
receiving a set of business pain points;
identifying the set of candidate business solutions based on the set of business pain points; and
determining the business value for each candidate business solution.

3. The method of claim 1, further comprising analyzing an impact of the set of proposed business solutions on a set of business components for a business entity.

4. The method of claim 3, wherein the analyzing includes:
obtaining a component business map that includes the set of business components; and
for each proposed business solution,
identifying at least one of the set of business components that is impacted by the proposed business solution; and
overlaying the proposed business solution on the corresponding at least one impacted business component in the component business map.

5. The method of claim 3, further comprising identifying a shortfall in the set of proposed business solutions based on the analyzing.

6. The method of claim 5, further comprising repeating the generating to address the shortfall.

7. The method of claim 1, further comprising providing the set of proposed business solutions for implementation.

8. A system for managing a set of business solutions, the system comprising:
a system for obtaining a set of candidate business solutions, wherein each candidate business solution comprises a corresponding set of resource requirements and a corresponding business value that is based on a risk and an expected return for the candidate business solution;
a system for obtaining a set of resource constraints; and
a system for generating a set of proposed business solutions that maximizes a total value while remaining within the set of resource constraints.

9. The system of claim 8, wherein the system for obtaining the set of candidate business solutions includes:
a system for receiving a set of business pain points;
a system for identifying the set of candidate business solutions based on the set of business pain points; and
a system for determining the business value for each candidate business solution.

10. The system of claim 8, further comprising a system for analyzing an impact of the set of proposed business solutions on a set of business components for a business entity.

11. The system of claim 10, wherein the system for analyzing includes:
a system for obtaining a component business map that includes the set of business components;
a system for identifying at least one of the set of business components that is impacted by a proposed business solution; and
a system for overlaying the proposed business solution on the corresponding at least one impacted business component in the component business map.

12. The system of claim 10, further comprising a system for identifying a shortfall in the set of proposed business solutions.

13. The system of claim 8, further comprising a system for providing the set of proposed business solutions for implementation.

14. A program product stored on a computer-readable medium, which when executed, enables a computer infrastructure to manage a set of business solutions, the program product comprising computer program code for enabling the computer infrastructure to:
obtain a set of candidate business solutions, wherein each candidate business solution comprises a corresponding set of resource requirements and a corresponding business value that is based on a risk and an expected return for the candidate business solution;
obtain a set of resource constraints; and
generate a set of proposed business solutions that maximizes a total value while remaining within the set of resource constraints.

15. The program product of claim 14, wherein the program code for enabling the computer infrastructure to obtain the set of candidate business solutions enables the computer infrastructure to:
receive a set of business pain points;
identify the set of candidate business solutions based on the set of business pain points; and
determine the business value for each candidate business solution.

16. The program product of claim 14, wherein the program code further enables the computer infrastructure to analyze an impact of the set of proposed business solutions on a set of business components for a business entity.

17. The program product of claim 16, wherein the program code for enabling the computer infrastructure to analyze enables the computer infrastructure to:
obtain a component business map that includes the set of business components;
identify at least one of the set of business components that is impacted by a proposed business solution; and
overlay the proposed business solution on the corresponding at least one impacted business component in the component business map.

18. The program product of claim 16, wherein the program code further enables the computer infrastructure to identify a shortfall in the set of proposed business solutions.

19. The program product of claim 14, wherein the program code further enables the computer infrastructure to provide the set of proposed business solutions for implementation.

20. A method of generating a system for managing a set of business solutions, the method comprising:
providing a computer infrastructure operable to:
obtain a set of candidate business solutions, wherein each candidate business solution comprises a corresponding set of resource requirements and a corresponding business value that is based on a risk and an expected return for the candidate business solution;
obtain a set of resource constraints; and
generate a set of proposed business solutions that maximizes a total value while remaining within the set of resource constraints.
